(19) United States
(12) Patent Application Publication
(10) Pub. No.: US 2015/0311018 A1
(43) Pub. Date: Oct. 29, 2015

(54) THERMOSENSITIVE PLATE FOR USE IN THERMOSTAT AND THERMOSTAT

(71) Applicant: WAKO ELECTRONICS CO., LTD., Osaka-shi, Osaka (JP)

(72) Inventor: Ryo TANAKA, Nara (JP)

(21) Appl. No.: 14/436,498

(22) PCT Filed: Sep. 24, 2013
(86) PCT No.: PCT/JP2013/075654

§ 371 Date: Apr. 17, 2015

(30) Foreign Application Priority Data
Oct. 19, 2012 (JP) 2012-231428

(51) Int. Cl. H01H 37/54

(52) U.S. Cl. CPC H01H 37/54; H01H 2235/028

(57) ABSTRACT

A plate-like thermosensitive plate for a thermostat has open-holes which extend therethrough. Radiation from the internal device reaches an inner lid and a guide pin of a thermostat through the open-holes, so that the inner lid and the guide pin can be heated along with the thermosensitive plate for use in a thermostat by the radiation passing through the open-holes. As a result, it is possible to minimize the risk that the heat of the thermosensitive plate for use in a thermostat escapes to the side of the inner lid and guide pin, whose temperatures are lower than that of the thermosensitive plate for use in a thermostat, and that the temperature rise of the thermosensitive plate for use in a thermostat is thereby delayed. Thus, the overheating of the internal device can be detected without delay, and the safety of the apparatus including the internal device can be increased.

### TECHNICAL FIELD

The present invention relates to a thermosensitive plate for use in a thermostat made of a material which deforms significantly corresponding to the temperature change, such as a bimetal. More specifically, the present invention relates to a thermosensitive plate provided with open-holes, and to a thermostat using the thermosensitive plate provided with the open-holes.

### BACKGROUND ART

Office equipment or consumer electronics such as copiers, printers and facsimiles most frequently includes a mechanism in which an internal device such as a heat roller is heated by a heating means such as a heater in order to allow these equipment and the like to be ready to use without delay, when the power is turned on or when returning from a stand by state. This internal device is provided with a temperature controlling means such as a thermistor, and this temperature controlling means allows for an electric current control of the heating means, so that the temperature of the internal device can be maintained within a predetermined temperature range. However, if a malfunction occurs in this temperature controlling means, the current control is not carried out appropriately, resulting in an overheating of the internal device. Therefore, a thermostat is provided in the vicinity of the internal device, so that, when the temperature of the internal device is increased to exceed a predetermined overheat temperature, the energization to the heating means is terminated without delay to prevent the emission of smoke or ignition associated with the overheating of the internal device.

For example, the thermostat disclosed in the below-identified Patent Document 1 includes: a thermosensitive plate for use in a thermostat configured to form a convex curve on the side of one surface thereof when the temperature of the thermosensitive plate for use in a thermostat is at a predetermined temperature or lower, and to deform by a snap action so as to form a convex curve on the side of the other surface thereof when the temperature of the thermosensitive plate for use in a thermostat is increased to exceed the predetermined temperature; a guide pin configured to be pressed down by the thermosensitive plate for use in a thermostat when the thermosensitive plate for use in a thermostat is deformed to form the convex curve on the side of the other surface, and to allow switching between a contact state and a non-contact state by bringing a movable contact and a stationary contact in the thermostat into and out of contact; and a, biasing member configured to bias the guide pin from the side of the other surface to the side of one surface of the thermosensitive plate for use in a thermostat, when the thermosensitive plate for use in a thermostat is deformed to form the convex curve on the side of the other surface.

When a radiation emitted from the internal device reaches the thermosensitive plate for use in a thermostat and the temperature of the thermosensitive plate is increased to exceed a predetermined temperature (a predetermined overheat temperature), this thermosensitive plate forming a convex curve on the side of one surface deforms by a snap action so as to form a convex curve on the side of the other surface. Corresponding to the deformation of the thermosensitive plate, the guide pin is pressed down against the biasing force of the biasing member provided with the movable contact, and this movement of the guide pin in the axial direction is configured to allow switching between the contact state and the non-contact state by bringing the movable contact and the stationary contact into and out of contact (in the case of thermostat disclosed in Patent Document 1, from the contact state to the non-contact state).

### PRIOR ART DOCUMENTS

### Patent Documents

Patent Document 1: JP 2008-47343 A

### SUMMARY OF THE INVENTION

### Problems to be Solved by the Invention

While the thermosensitive plate for use in a thermostat used in the thermostat according to Patent Document 1 is heated by receiving the radiation from the side of its top surface, the guide pin, which is disposed at a position shielded by the thermosensitive plate for use in a thermostat, is not heated by the radiation. Therefore, the temperature of the guide pin becomes lower compared to that of the thermosensitive plate for use in a thermostat, and the heat of the thermosensitive plate for use in a thermostat is likely to escape from its rear surface, which is facing or in contact with the guide pin, to the side of the guide pin. As a result, the temperature rise of the thermosensitive plate for use in a thermostat may be delayed compared to the temperature rise of the internal device. This leads to a problem that the internal device is significantly overheated by the time the thermostat is activated, resulting in an emission of smoke or ignition in the internal device.

In the thermosensitive plate for use in a thermostat used in the thermostat disclosed in the Patent Document 1, efforts have been made to reduce the shielding of the radiation by the thermosensitive plate for use in a thermostat, by forming circular arc-shaped notches at portions of the thermosensitive plate for use in a thermostat, or by holding the thermosensitive plate only at its four corners. However, the guide pin is often provided in the vicinity of the central axis of the thermostat, and the above mentioned efforts alone are usually not sufficient to allow the heating of the guide pin.

Accordingly, an object of the present invention is to provide a way to detect the overheating of an internal device without delay, and to enhance the safety of the apparatus including the internal device.

### Means for Solving the Problems

In order to solve the above mentioned problems, the present invention has adapted the following constitution.

A thermosensitive plate for use in a thermostat which is a plate member configured to form a convex curve on the side of one surface thereof when the temperature of the plate member is at a predetermined temperature or lower, and to deform by a snap action so as to form a convex curve on the side of the other surface thereof when the temperature of the plate member is increased to exceed the predetermined temperature;

wherein the thermostat comprises: a guide pin, a biasing member provided with a movable contact, and a stationary contact;

wherein the plate member is configured to press down the guide pin in an axial direction against a biasing force of the biasing member provided with the movable contact of the thermostat, when the plate member is deformed to form the convex curve on the side of the other surface;

wherein the movement of the guide pin in the axial direction is configured to allow switching between a contact state and a non-contact state by bringing the movable contact and the stationary contact into and out of contact;

wherein open-holes extending through the plate member from the side of one surface to the side of the other surface thereof and configured to allow the radiation from an internal device to pass therethrough are formed on the plate member at positions not adjacent to the outer edge of the plate member; and

wherein the radiation passing through the open-holes is capable of heating the guide pin, which is disposed at a position corresponding to the center of the plate member on the side of the other surface thereof.

If the open-holes are provided in the thermosensitive plate for use in a thermostat, as described above, the radiation emitted from the internal device reaches the guide pin, which is disposed at a position shielded by the thermosensitive plate for use in a thermostat, through the open-holes. This allows the guide pin to be heated along with the thermosensitive plate for use in a thermostat, and thus it is possible to minimize the risk that the heat of the thermosensitive plate for use in a thermostat escapes to the side of the guide pin and that the temperature rise of the thermosensitive plate is thereby delayed.

The positions at which the open-holes are formed are not particularly limited, as long as the function of the open-holes to allow the radiation to pass therethrough in order to heat the guide pin is secured. The open-holes can be formed not only at a position corresponding to that of the guide pin, but also at positions somewhat apart from the position corresponding to that of the guide pin. This is because, although the radiation passing through the open-holes may not directly reach the guide pin if the open-holes are formed at positions somewhat apart from that of the guide pin, it is possible that the radiation eventually reaches the guide pin due to scattering of the radiation in the vicinity of the open-holes. Further, if one or more of the open-hole(s) are formed at a position(s) corresponding to that of the guide pin, the contact area between the guide pin and the thermosensitive plate for use in a thermostat is reduced, and even in cases where the temperature of the guide pin is lower than the temperature of the thermosensitive plate for use in a thermostat, the escape of heat from the thermosensitive plate for use in a thermostat to the guide pin can be minimized.

As described above, in cases where one or more of the open-hole(s) are formed at a position corresponding to that of the guide pin, it should be noted that it is necessary to determine the shape and the size of the open-holes and guide pin such that the situation in which the guide pin gets stuck in one of the open-holes does not occur. If the guide pin gets stuck in one of the open-holes, it is impossible to smoothly carry out the pressing down of the guide pin corresponding to the deformation of the thermosensitive plate for use in a thermostat by a snap action.

The number, size, shape (circular shape or polygonal shape such as a triangle or rectangle), arrangement and the like of the open-holes can be changed as appropriate, as long as the above mentioned function of the open-holes can be secured. Further, the external shape of the thermosensitive plate 1 for use in a thermostat can be not only a rectangle, but also a square, circle, or the like. Alternatively, a flange portion can be provided which stands on the side of one surface of the thermosensitive plate, at its outer edge.

In the thermosensitive plate for use in a thermostat having the above mentioned constitution, it is possible to configure the thermosensitive plate for use in a thermostat such that the radiation passing through the open-holes is capable of directly heating an inner lid holding the guide pin slidably in the direction in which the thermosensitive plate deforms by the snap action.

When the guide pin is slidably held by the inner lid, even if the guide pin alone is heated by the radiation, the heat of the guide pin escapes to the inner lid, whose temperature is lower relative to that of the guide pin, and there are cases where the guide pin may not be sufficiently heated. As a result, there is a potential risk that the activation of the thermostat, which is achieved by the deformation of the thermosensitive plate for use in a thermostat, could be delayed. If the thermostat is configured such that the radiation passing through the open-holes provided in the thermosensitive plate for use in a thermostat is capable of heating not only the guide pin but also the inner lid, it is possible to prevent the temperature fall of the guide pin, as well as to prevent the heat of the thermosensitive plate for use in a thermostat from escaping to the inner lid when the thermosensitive plate is brought into direct contact with the inner lid.

In addition, in each the above mentioned constitutions, the plate member may be a laminate obtained by laminating in a thickness direction a plurality of materials having a different thermal expansion coefficient.

This laminate (such as a bimetal) is capable of deforming significantly corresponding to the temperature change, due to the difference in the thermal expansion coefficient between materials constituting the laminate. Therefore, it is possible to detect the overheating of an internal device without delay and to immediately block the energization to the internal device.

In a thermostat comprising: a thermosensitive plate for use in a thermostat configured to form a convex curve on the side of one surface thereof when the temperature of the thermosensitive plate for use in a thermostat is at a predetermined temperature or lower, and to deform by a snap action so as to form a convex curve on the side of the other surface thereof when the temperature of the thermosensitive plate for use in a thermostat is increased to exceed the predetermined temperature; a biasing member provided with a movable contact; a stationary contact; a guide pin configured to be pressed down by the thermosensitive plate for use in a thermostat when the thermosensitive plate for use in a thermostat is deformed to form the convex curve on the side of the other surface, and to allow switching between a contact state and a non-contact state by bringing the movable contact and the stationary contact in the thermostat into and out of contact; wherein the biasing member is configured to bias the guide pin from the side of the other surface to the side of one surface of the thermosensitive plate for use in a thermostat, when the thermosensitive plate for use in a thermostat is deformed to form the convex curve on the side of the other surface;

it is possible to use the thermosensitive plate for use in a thermostat having the above mentioned constitutions, as the thermosensitive plate for use in a thermostat.

In the thermostat having the above mentioned constitution, both the thermosensitive plate for use in a thermostat and the guide pin, or all of the thermosensitive plate for use in a thermostat, the guide pin and the inner lid, can be efficiently heated by the radiation from the internal device. Therefore, it is possible to minimize the risk that the heat of the thermosensitive plate for use in a thermostat escapes to the guide pin and the like and that the temperature rise of the thermosensitive plate is thereby delayed.

### EFFECT OF THE INVENTION

In the present invention, open-holes are provided in the thermosensitive plate for use in a thermostat, so that the radiation from the internal device is allowed to pass through the open-holes and to reach the guide pin in the thermostat. With this arrangement, the guide pin, which is disposed at a position shielded from the radiation by the thermosensitive plate for use in a thermostat, can be heated by the radiation, and it is possible to minimize the risk that the temperature rise of the thermosensitive plate for use in a thermostat is delayed due to the escape of heat from the thermosensitive plate to the guide pin. This allows for a detection of the overheating of the internal device without delay and an increased safety of the internal device.

### BRIEF DESCRIPTION OF THE DRAWINGS

FIG. 1 is a top view of a thermosensitive plate for use in a thermostat according to the present invention: (a) shows one in which four circular open-holes are provided; (b) shows one in which six circular open-holes are provided; (c) shows one in which three circular open-holes are provided; and (d) shows one in which four circular open-holes are provided with two circular arc-shaped notches formed on its two sides.

FIG. 2 is a longitudinal sectional view of the thermostat according to the present invention: (a) shows one in an inactivated state; and (b) shows one in an activated state.

FIG. 3 is a top view of the thermostat shown in FIG. 2.

FIG. 4 is a graph showing the comparison of the maximum temperature reached by a heat roller, between the case in which the thermosensitive plate for use in a thermostat provided with open-holes is used and the case in which the thermosensitive plate for use in a thermostat without open-holes is used.

### MODE FOR CARRYING OUT THE INVENTION

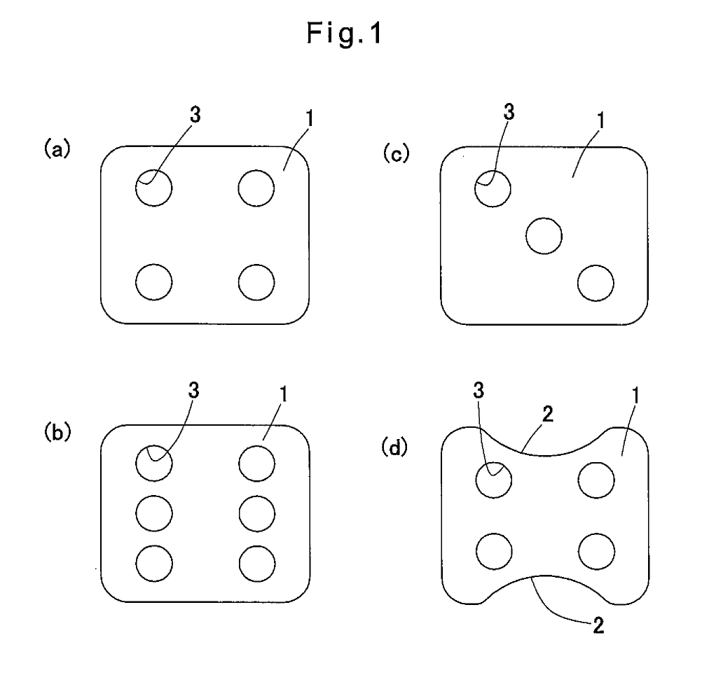

FIGS. 1 (a) to (d) are top views of the thermosensitive plate I for use in a thermostat according to the present invention. This thermosensitive plate 1 for use in a thermostat is a roughly rectangular plate member (shown in FIGS. 1 (a) to (c)), or a roughly rectangular plate member provided with two circular arc-shaped notches 2 on its opposing long sides (shown in FIG. 1 (d)), which plate member is configured to form a convex curve on the side of one surface thereof when the temperature of the plate member is at a predetermined temperature or lower, and to deform by a snap action so as to form a convex curve on the side of the other surface thereof when the temperature of the plate member is increased to exceed the predetermined temperature. This plate member is a laminate (bimetal material) obtained by laminating in the thickness direction two materials having a different thermal expansion coefficient. This thermosensitive plate 1 for use in a thermostat is provided with open-holes 3 extending through the thermosensitive plate from the side of one surface to the side of the other surface thereof. The number of the open-holes 3 can be decided as appropriate, as long as at least one is provided. However, it is preferred that from three to six open-holes 3 be provided as shown in FIGS. 1 (a) to (d). This is because, the open-holes 3 allow radiation r emitted from an internal device to pass therethrough so that the radiation r effectively reaches the an inner lid 4 and a guide pin 5 to be described later, without negatively affecting the deformation capability of the thermosensitive plate 1 for use in a thermostat.

If one of the open-holes 3 is formed at a position corresponding to that of the guide pin 5, as shown in FIG. 1 (c), the radiation r is able to directly reach the guide pin 5, and the guide pin 5 can be heated even more efficiently. At this time, if the open- holes 3 are formed to have a diameter smaller than that of the top end portion of the guide pin 5, the situation can be avoided in which the guide pin 5 gets stuck in one of the open-holes 3 to cause malfunction in a thermostat 6.

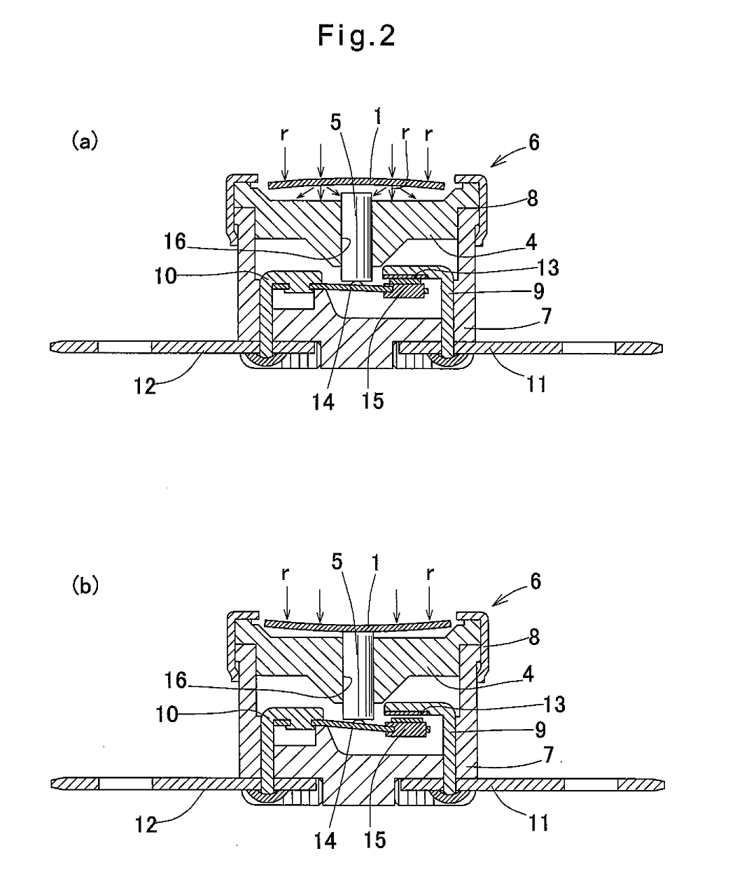

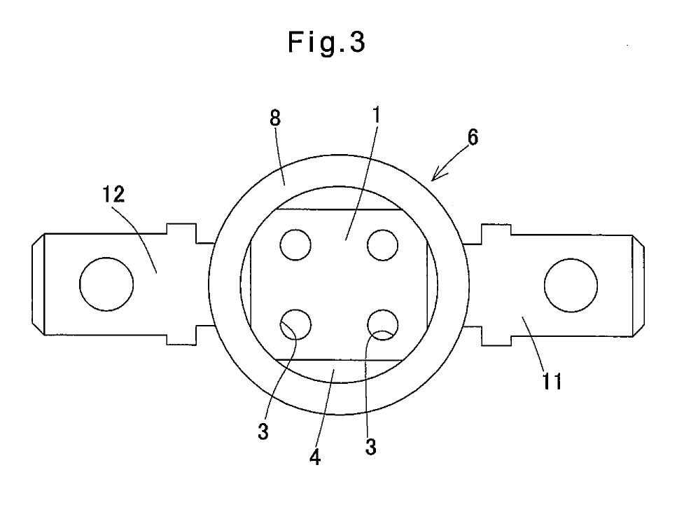

FIGS. 2 (a) and (b), and FIG. 3 are longitudinal sectional views and a top view of the thermostat 6 according the present invention, respectively. The thermostat 6 includes a base 7 in the shape of a cylinder having a bottom and an open upper end, the inner lid 4 which closes the open upper end of the base 7, and a cap 8 fixing the inner lid 4 to the base 7; all of which constitute the external shape of the thermostat 6. The material of the inner lid 4 can be selected as appropriate from ceramics, resins and the like, taking into consideration various conditions such as the temperature at which the thermostat is set to be activated.

A first connector 9 and a second connector 10 are provided at an interval from each other within the base 7. The first connector 9 is connected to a first terminal 11, and the second connector 10 is connected to a second terminal 12, respectively, to permit conduction between the inside and the outside of the base 7. A stationary contact 13 is provided on one side of the end portion of the first connector 9. On the other hand, one end portion of a flat spring 14 as a biasing member 14 is attached to one side of the end portion of the second connector 10, and a movable contact 15 is provided at the other end portion of the flat spring 14. This movable contact 15 is pressed to the stationary contact 13 by the biasing force of the flat spring 14, and when the thermostat 6 is in an inactivated state, the stationary contact 13 and the movable contact 15 are in contact to permit the conduction therebetween.

A through hole 16 is formed to extend through the center of the inner lid 4, and the guide pin 5 is inserted into the through hole 16. The guide pin 5 is configured to be slidable inside the through hole 16 in the direction in which the thermosensitive plate 1 for use in a thermostat deforms by the snap action, when the thermosensitive plate 1 for use in a thermostat is deformed to form the convex curve on the side of the other surface.

The thermosensitive plate 1 for use in a thermostat provided with the open-holes 3 are mounted above the inner lid 4, and the cap 8 is placed over the inner lid 4. The cap 8 is fixed to the base 7 by caulking, thereby preventing the thermosensitive plate 1 for use in a thermostat from falling off the inner lid 4. The thermosensitive plate 1 for use in a thermostat is configured to form a convex curve on the side of one surface thereof when the temperature of the thermosensitive plate 1 for use in a thermostat is at a predetermined temperature or lower, (see FIG. 2 (a)), and to deform by a snap action so as to form a convex curve on the side of the other surface thereof when the temperature of the thermosensitive plate 1 for use in a thermostat is increased to exceed the predetermined temperature (see FIG. 2 (b)). When the thermosensitive plate 1 for use in a thermostat is deformed to form the convex curve on the side of the other surface, the thermosensitive plate 1 comes into contact with the guide pin 5, and presses down the guide pin 5 deeper into the through hole 16 against the biasing force of the flat spring 14. This causes the movable contact 15 provided at the end portion of the flat spring 14 to move away from the stationary contact 13, thereby blocking the conduction between the stationary contact 13 and the movable contact 15 (the status in which the thermostat 6 is activated).

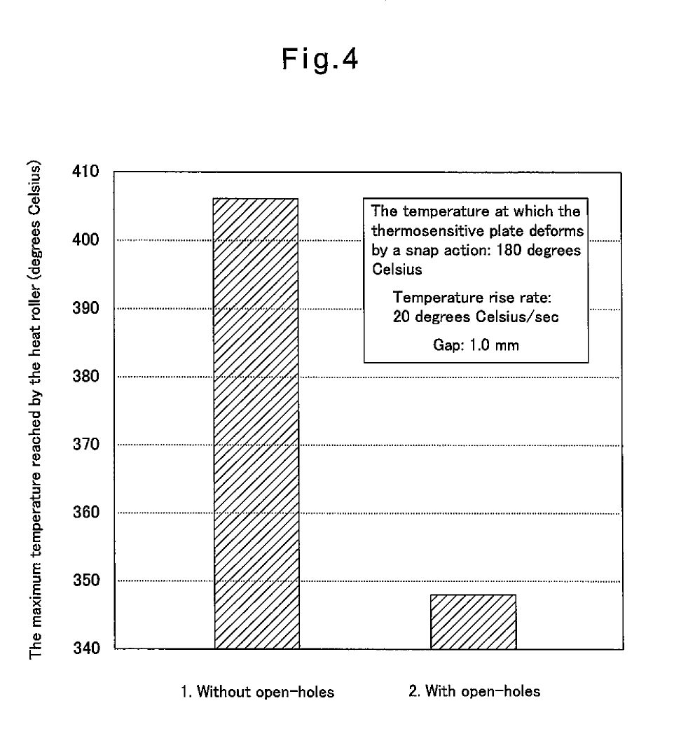

An experiment of heat control was performed using the thermostat 6 having the constitution shown in FIG. 2, in the case where a heat roller in the fixing unit of the printer is provided with a halogen heater as a heating source and the heat roller is heated by this halogen heater. FIG. 4 shows the comparison of the maximum temperature reached by the heat roller, between the case in which the thermosensitive plate 1 for use in a thermostat provided with open-holes 3 is used and the case in which the thermosensitive plate 1 without the open-holes 3 is used. The heat control by the thermostats 6 was measured, using two thermosensitive plates 1 for use in a thermostat having a different shape and each composed of a bimetal material which deforms by a snap action when its temperature reaches 180° C., respectively. One of the thermosensitive plates 1 for use in a thermostat is provided with four circular open-holes 3, while the other is formed with no open-holes 3. The thermosensitive plate 1 for use in a thermostat in each of the thermostats 6 was disposed at a position 1 mm away from the surface of the heat roller, and the measurement of the temperature was carried out. The output of the halogen heater was controlled so that the temperature rise rate of the heat roller achieves 20° C./sec.

When the thermosensitive plate 1 for use in a thermostat without open-holes 3 was used, the thermostat 6 was activated when the temperature of the heat roller has reached about 406° C. In contrast, when the thermosensitive plate 1 for use in a thermostat provided with open-holes 3 was used, the thermostat 6 was activated when the temperature of the heat roller has reached about 348° C. In other words, by using the thermostat 6 including the thermosensitive plate 1 for use in a thermostat provided with the open-holes 3 according to the present invention, the temperature rise of the heat roller, whose temperature is the object to be measured, can be detected without delay. Thus, it is possible to activate the thermostat 6 and to block the energization to the halogen heater, before the heat roller is overheated. This allows for preventing the occurrence of smoke emission or ignition due to overheating of the heat roller.

In the above mentioned embodiment of the thermosensitive plate 1 for use in a thermostat (see FIG. 1), three to six open-holes 3 are provided. However, the number, size, shape (circular shape or polygonal shape such as a triangle or rectangle), arrangement and the like of the open-holes 3 can be changed as appropriate, as long as the open-holes 3 allow the radiation r to pass therethrough so as to reach the inner lid 4 and the guide pin 5, and the deformation behavior of the thermosensitive plate sufficient to resist against the biasing force of the biasing member 14 (such as the flat spring) can be secured. Further, the external shape of the thermosensitive plate 1 for use in a thermostat can be not only a rectangle, but also a square, circle, or the like. In addition, a flange portion can be provided which stands up on the side of one surface of the thermosensitive plate, at its outer edge.

As the material for the thermosensitive plate 1 for use in a thermostat, it is also possible to use, instead of a bimetal, a laminate obtained by laminating in the thickness direction three materials having a different thermal expansion coefficient (a trimetal material), or other materials which deform significantly corresponding to the temperature change.

In the above mentioned embodiment, the thermostat 6 of a type in which the stationary contact 13 and the movable contact 15 are in contact to permit the conduction therebetween when the thermostat 6 is in an inactivated state (when the temperature of the thermosensitive plate 1 for use in a thermostat is at a predetermined temperature or lower) is described. However, it is also possible to use the thermosensitive plate 1 for use in a thermostat according to the present invention, in the thermostat 6 of a type in which, as opposed to the above embodiment, the stationary contact 13 and the movable contact 15 are not in contact and the conduction therebetween is blocked, when the thermostat 6 is in an inactivated state.

Further, there are the thermostat 6 of a type which needs to be replaced once it has been activated (when the temperature of the thermosensitive plate 1 for use in a thermostat is increased to exceed the predetermined temperature), and the thermostat 6 of a type which is capable of being reused, by being returned to an inactivated state, automatically or manually, through cooling the thermostat 6 below its deactivation temperature after it has been activated. The constitution of the present invention can be adapted to the thermosensitive plate 1 for use in a thermostat used in any of these types of the thermostat, and to the thermostat 6 of any of these types.

The above mentioned embodiment is merely an example embodying the present invention. It should be noted that the shape, material and the like of the respective portions and members used in the thermosensitive plate 1 for use in a thermostat and the thermostat 6 can be changed as appropriate, as long as the object of the present invention to detect the overheating of an internal device without delay and to block the energization thereto, as well as to increase the safety of the apparatus including the internal device can be achieved.

### DESCRIPTION OF SYMBOLS

1 thermosensitive plate for use in a thermostat
2 notch
3 open-hole
4 inner lid
5 guide pin
6 thermostat
7 base
8 cap
9 first connector
10 second connector
11 first terminal
12 second terminal
13 stationary contact
14 biasing member (flat spring)
15 movable contact
16 through hole
r radiation

1. A thermosensitive plate (1) for use in a thermostat which is a plate member configured to form a convex curve on a side of one surface thereof when a temperature of the plate member is at a predetermined temperature or lower, and to deform by a snap action so as to form a convex curve on a side of another surface thereof when the temperature of the plate member is increased to exceed the predetermined temperature;
wherein the thermostat (6) comprises: a guide pin (5), a biasing member (14) provided with a movable contact (15), and a stationary contact (13);
wherein the plate member is configured to press down the guide pin (5) in an axial direction against a biasing force of the biasing member (14) provided with the movable contact (15) of the thermostat (6), when the plate member is deformed to form the convex curve on the side of the other surface;
wherein the movement of the guide pin (5) in the axial direction is configured to allow switching between a contact state and a non-contact state by bringing the movable contact (15) and the stationary contact (13) into and out of contact;
wherein open-holes (3) extending through the plate member from the side of one surface to the side of the other surface thereof and configured to allow the radiation (r) from an internal device to pass therethrough are formed on the plate member at positions not adjacent to an outer edge of the plate member; and
wherein the radiation (r) passing through the open-holes (3) is capable of heating the guide pin (5), which is disposed at a position corresponding to the center of the plate member on the side of the other surface thereof.

2. The thermosensitive plate (1) for use in a thermostat according to claim 1, wherein the radiation (r) passing through the open-holes (3) is capable of directly heating an inner lid (4) holding the guide pin (5) slidably in the direction in which the plate member deforms by the snap action.

3. The thermosensitive plate (1) for use in a thermostat according to claim 1, wherein the plate member is a laminate obtained by laminating in a thickness direction a plurality of materials having a different thermal expansion coefficient.

4. A thermostat comprising:
a thermosensitive plate (1) for use in a thermostat configured to form a convex curve on a side of one surface thereof when a temperature of the thermosensitive plate (1) for use in a thermostat is at a predetermined temperature or lower, and to deform by a snap action so as to form a convex curve on a side of another surface thereof when the temperature of the thermosensitive plate (1) for use in a thermostat is increased to exceed the predetermined temperature;
a biasing member (14) provided with a movable contact (15);
a stationary contact (13);
a guide pin (5) configured to be pressed down by the thermosensitive plate (1) for use in a thermostat when the thermosensitive plate (1) for use in a thermostat is deformed to form the convex curve on the side of the other surface, and to allow switching between a contact state and a non-contact state by bringing the movable contact and the stationary contact in the thermostat into and out of contact;
wherein the biasing member (14) is configured to bias the guide pin (5) from the side of the other surface to the side of one surface of the thermosensitive plate (1) for use in a thermostat, when the thermosensitive plate (1) for use in a thermostat is deformed to form the convex curve on the side of the other surface; and
wherein the thermosensitive plate (1) for use in a thermostat according to claim 1 is used as the thermosensitive plate (1) for use in a thermostat.

5. The thermosensitive plate (1) for use in a thermostat according to claim 2, wherein the plate member is a laminate obtained by laminating in a thickness direction a plurality of materials having a different thermal expansion coefficient.

6. A thermostat comprising:
a thermosensitive plate (1) for use in a thermostat configured to form a convex curve on a side of one surface thereof when a temperature of the thermosensitive plate (1) for use in a thermostat is at a predetermined temperature or lower, and to deform by a snap action so as to form a convex curve on a side of another surface thereof when the temperature of the thermosensitive plate (1) for use in a thermostat is increased to exceed the predetermined temperature;
a biasing member (14) provided with a movable contact (15);
a stationary contact (13);
a guide pin (5) configured to be pressed down by the thermosensitive plate (1) for use in a thermostat when the thermosensitive plate (1) for use in a thermostat is deformed to form the convex curve on the side of the other surface, and to allow switching between a contact state and a non-contact state by bringing the movable contact and the stationary contact in the thermostat into and out of contact;
wherein the biasing member (14) is configured to bias the guide pin (5) from the side of the other surface to the side of one surface of the thermosensitive plate (1) for use in a thermostat, when the thermosensitive plate (1) for use in a thermostat is deformed to form the convex curve on the side of the other surface; and
wherein the thermosensitive plate (1) for use in a thermostat according to claim 2 is used as the thermosensitive plate (1) for use in a thermostat.

7. A thermostat comprising:
a thermosensitive plate (1) for use in a thermostat configured to form a convex curve on a side of one surface thereof when a temperature of the thermosensitive plate (1) for use in a thermostat is at a predetermined temperature or lower, and to deform by a snap action so as to form a convex curve on a side of another surface thereof when the temperature of the thermosensitive plate (1) for use in a thermostat is increased to exceed the predetermined temperature;
a biasing member (14) provided with a movable contact (15);
a stationary contact (13);
a guide pin (5) configured to be pressed down by the thermosensitive plate (1) for use in a thermostat when the thermosensitive plate (1) for use in a thermostat is deformed to form the convex curve on the side of the other surface, and to allow switching between a contact state and a non-contact state by bringing the movable contact and the stationary contact in the thermostat into and out of contact;
wherein the biasing member (14) is configured to bias the guide pin (5) from the side of the other surface to the side of one surface of the thermosensitive plate (1) for use in a thermostat, when the thermosensitive plate (1) for use in a thermostat is deformed to form the convex curve on the side of the other surface; and
wherein the thermosensitive plate (1) for use in a thermostat according to claim 3 is used as the thermosensitive plate (1) for use in a thermostat.
